(19) United States
(12) Patent Application Publication
(10) Pub. No.: US 2017/0276860 A1
(43) Pub. Date: Sep. 28, 2017

(54) RETROFIT LAMP AND VEHICLE HEADLIGHT WITH RETROFIT LAMP

(71) Applicant: OSRAM GmbH, Munich (DE)

(72) Inventor: Michael Boenigk, Berlin (DE)

(21) Appl. No.: 15/462,928

(22) Filed: Mar. 20, 2017

(30) Foreign Application Priority Data
Mar. 22, 2016 (DE) 10 2016 204 697.7

(51) Int. Cl. F21V 8/00; F21V 29/76; F21S 8/10

(52) U.S. Cl. CPC G02B 6/0031; F21S 48/1154; F21S 48/328; F21V 29/763; F21S 48/1241; F21Y 2115/10

(57) ABSTRACT

In various embodiments, a retrofit lamp for vehicle headlight is provided. The retrofit lamp includes at least one semiconductor light source, a plurality of light output coupling optical units, and a light-guide apparatus which is embodied to guide light from the at least one semiconductor light source to the light output coupling optical units. The light-guide apparatus includes at least one light-exit end, at which the light output coupling optical units are arranged spaced apart from one another.

### CROSS-REFERENCE TO RELATED APPLICATION

This application claims priority to German Patent Application Serial No. 10 2016 204 697.7, which was filed Mar. 22, 2016, and is incorporated herein by reference in its entirety.

### TECHNICAL FIELD

Various embodiments relate generally to a retrofit lamp for a vehicle headlight and a vehicle headlight including a retrofit lamp.

### BACKGROUND

The phrase retrofit lamp denotes a lamp which includes one or more semiconductor light sources as a light source and which includes a base which is compatible to a base of an incandescent lamp or a discharge lamp such that the retrofit lamp, as a replacement for an incandescent lamp or a discharge lamp, may be inserted into, and operated in, a socket of a lamp corresponding to the base.

In particular, a retrofit lamp for vehicle headlights may be inserted into a socket of a vehicle headlight and operated as a vehicle headlight lamp because it includes a base which is compatible with the base of an incandescent lamp or discharge lamp embodied as a vehicle headlight lamp.

### SUMMARY

In various embodiments, a retrofit lamp for vehicle headlight is provided. The retrofit lamp includes at least one semiconductor light source, a plurality of light output coupling optical units, and a light-guide apparatus which is embodied to guide light from the at least one semiconductor light source to the light output coupling optical units. The light-guide apparatus includes at least one light-exit end, at which the light output coupling optical units are arranged spaced apart from one another.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic illustration of the arrangement of semiconductor light sources, light-guide apparatus and light output coupling optical units of the retrofit lamp in accordance with various embodiments;

FIG. 2 shows a schematic, partly cut illustration of the retrofit lamp in accordance with various embodiments;

FIG. 3 shows a schematic, partly cut illustration of the base of the retrofit lamp in accordance with various embodiments;

FIG. 4 shows a side view of the light output coupling optical units and a portion of the light-guide apparatus of the retrofit lamp depicted in the FIG. 1 to FIG. 3, in accordance with various embodiments, in a magnified schematic illustration;

FIG. 5 shows a top view of the light output coupling optical units depicted in FIG. 4 and of the portion of the light-guide apparatus in a magnified, schematic illustration;

FIG. 6 shows a bottom view of the light output coupling optical units depicted in FIG. 4 and FIG. 5 and of the portion of the light-guide apparatus in a magnified, schematic illustration;

FIG. 7 shows a plan view of the light-exit end of the light-guide apparatus depicted in FIG. 4 to FIG. 6 and light output coupling optical units in a magnified, schematic illustration; and

FIG. 8 shows a schematic, partly cut illustration of a vehicle headlight including the retrofit lamp depicted in FIG. 2.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

Various embodiments provide a retrofit lamp which is compatible with a vehicle headlight lamp embodied as a high-pressure discharge lamp or incandescent lamp and usable as a replacement for such a lamp in a vehicle headlight.

The retrofit lamp according to various embodiments is provided as a light source for vehicle headlight and includes at least one semiconductor light source, a plurality of light output coupling optical units and a light-guide apparatus which is embodied to guide light from the at least one semiconductor light source to the light output coupling optical units. The light-guide apparatus includes at least one light-exit end, at which the light output coupling optical units are arranged spaced apart from one another.

On account of the aforementioned features, the retrofit lamp according to various embodiments produces a light distribution during the operation thereof, said light distribution substantially corresponding to the light distribution of a high-pressure discharge lamp or incandescent lamp for vehicle headlight. Therefore, the retrofit lamp according to various embodiments may be used as a replacement for such a vehicle headlight lamp. The use of a plurality of light output coupling optical units facilitates the reproduction of the geometry of light-emitting portions of an electric arc of a high-pressure discharge lamp or of a filament of an incandescent lamp by way of the retrofit lamp according to various embodiments.

The light-guide apparatus of the retrofit lamp according to various embodiments has a step-like embodiment at the at least one light-exit end and the light output coupling optical units are respectively arranged at one step of the light-exit end of the at least one light guide. This allows a desired spatial arrangement of the light output coupling optical units and different distances between the light output coupling optical units to be implemented in a simple manner.

The light output coupling optical units of the retrofit clamp according to various embodiments each have a rotationally symmetric embodiment in respect of an axis of rotational symmetry in order to generate symmetric light distribution.

In accordance with an embodiment of the retrofit lamp, the light output coupling optical units thereof include at least one cone-like or frustum-like or pyramid-shaped portion. In addition to a cone-shaped portion of the light output coupling optical unit, the term cone-like portion of the light output coupling optical unit also includes those modifications of the cone-shaped portion of the light output coupling optical unit which are formed by one or more depressions or elevations in the lateral cone surface. In various embodiments, this also includes a portion of the light output coupling optical unit with a concavely or convexly arched lateral cone surface, in which the lateral area is produced by rotating a concavely or convexly arched curve about the cone axis. That is to say, the lateral area is formed by a concavely or convexly arched curve in a longitudinal section through the cone containing the cone axis, said curve connecting the cone tip to an edge point of the cone base area. Additionally, the term cone-like portion of the light output coupling optical unit also includes those modifications of the cone-shaped portion of the light output coupling optical unit, in which, in cross-sections perpendicular to the cone axis through the portion of the light output coupling optical unit, the lateral area is formed in each case by a regular polygon. The circumference and the area of the polygon reduce in the direction of the second end of the light output coupling optical unit and the number of corners of the polygon remains unchanged. The lateral area and the corresponding portion of the light output coupling optical unit have an n-fold rotational symmetry about a longitudinal axis extending perpendicular to the base area and through the cone tip of the cone-like portion of the light output coupling optical unit as a result thereof, where n denotes the number of corners of the regular polygon. The term n-fold rotational symmetry means that the cone-like portion of the light output coupling optical unit is invariant in relation to rotations by an angle of 360°/n about the longitudinal axis thereof. Preferably, n is greater than or equal to 12. The surface or the lateral area of the cone-like portion of the light output coupling optical unit has a light-reflecting embodiment.

In addition to a frustum-shaped portion of the light output coupling optical unit, the term frustum-like portion of the light output coupling optical unit also analogously includes those modifications of the frustum-shaped portion of the light output coupling optical unit which are formed by one or more depressions or elevations in the lateral frustum surface. In various embodiments, this also includes a portion of the light output coupling optical unit with a concavely or convexly arched lateral frustum surface, in which the lateral area is produced by rotating a concavely or convexly arched curve about the frustum axis. That is to say, the lateral area is formed by a concavely or convexly arched curve in a longitudinal section through the frustum containing the frustum axis, said curve connecting an edge point of the top area of the frustum to an edge point of the base area of the frustum. Additionally, the term frustum-like portion of the light output coupling optical unit also includes those modifications of the frustum-shaped portion of the light output coupling optical unit, in which, in cross-sections perpendicular to the frustum axis through the corresponding portion of the light output coupling optical unit, the lateral area is formed in each case by a regular polygon. The circumference and the area of the polygon reduce in the direction of the second end of the light output coupling optical unit and the number of corners of the polygon remains unchanged. The lateral area and the corresponding portion of the light output coupling optical unit have an n-fold rotational symmetry about a longitudinal axis oriented perpendicular to the base area and top area of the frustum-like portion of the light output coupling optical unit and extending centrally through the base area and top area of the frustum-like light output coupling optical unit as a result thereof, where n denotes the number of corners of the regular polygon. The term n-fold rotational symmetry means that the frustum-like light output coupling optical unit is invariant in relation to rotations by an angle of 360°/n about the longitudinal axis thereof. In various embodiments, n is greater than or equal to 12. The surface or the lateral area of the frustum-like light output coupling optical unit has a light-reflecting embodiment.

In various embodiments, the aforementioned cone-like or frustum-like portions of the light output coupling optical units facilitate an emission of the light without back reflection into the light-guide apparatus. Moreover, this causes the light guided in the light-guide apparatus to be reflected in different directions and, in various embodiments, also to be deflected from an axis of longitudinal extent of the light-guide apparatus.

In various embodiments, the light output coupling optical units in the retrofit lamp are each formed by surfaces which have a light-reflecting embodiment and are arranged within the light-guide apparatus. As a result, the light output coupling optical units may be combined with the light-guide apparatus in a simple and space-saving manner. In accordance with various embodiments, the light output coupling optical units are formed by surfaces with a light-reflecting embodiment, which each delimit a cavity arranged within the light-guide apparatus.

The light-guide apparatus of the retrofit lamp according to various embodiments may have a rod-like embodiment and includes at least one light-entrance end facing the at least one semiconductor light source and at least one light-exit end facing away from the at least one semiconductor light source in order to facilitate a short light guide from the at least one semiconductor light source to the light output coupling optical units. The light-guide apparatus may be embodied as an optical waveguide which guides light by means of total-internal reflection from at least one light-entrance end to a light-exit end at which the light output coupling optical units are arranged.

The light-guide apparatus of the retrofit lamp according to various embodiments consists of transparent material, preferably a glass or a transparent plastic, in order to largely avoid light absorption in the light guide material.

The retrofit lamp according to various embodiments may include a base which defines a reference plane for aligning the light output coupling optical unit. As a result, aligning the light output coupling optical units of the retrofit lamp according to various embodiments in respect of an optical axis of a reflector of the vehicle headlight is facilitated when said retrofit lamp is used in the vehicle headlight.

In various embodiments, the axes of rotational symmetry of the light output coupling optical units of the retrofit lamp according to various embodiments are aligned perpendicular to the reference plane. This ensures that the light output coupling optical units have a desired alignment with respect to the optical axis of a reflector of the vehicle headlight when installing the retrofit lamp according to various embodiments in the vehicle headlight.

In various embodiments, the retrofit lamp according to various embodiments includes at least two light output coupling optical units which are arranged in such a way that the distance between a first light output coupling optical unit and the reference plane of the base of the retrofit lamp is less than a value E and the distance between a second light output coupling optical unit and the reference plane is greater than the value E, wherein the value E is either 27.1 mm or 18.0 mm. This ensures that the light output coupling optical units of the retrofit lamp are placed at the same location where electric arc attachments of an electric arc of a replaced high-pressure discharge lamp were placed when a high-pressure discharge lamp of ECE category D1R, D1S, D2R, D2S, D3R, D3S, D4R, D4S, D5S, D6S, D8R, D8S or D9S, embodied as a vehicle headlight lamp, is replaced by a retrofit lamp according to various embodiments. The value E is 18.0 mm for a retrofit lamp according to various embodiments for replacing a high-pressure discharge lamp of ECE category D5S and the value E is 27.1 mm for a retrofit lamp according to various embodiments for replacing a high-pressure discharge lamp of the other aforementioned ECE categories.

In various embodiments, a third light output coupling optical unit is provided in the retrofit lamp according to various embodiments and the distance between the third light output coupling optical unit and the reference plane of the base is greater than the distance between the first light output coupling optical unit and the reference plane of the base and less than the distance between the second light output coupling optical unit and the reference plane of the base. As a result, the center of the light-emitting discharge arc of a high-pressure discharge lamp may be reproduced. Moreover, it is also possible to imitate convection-caused curvature of the discharge arc by virtue of the axis of rotational symmetry of the third light output coupling optical unit being arranged with parallel offset from the axes of rotational symmetry of the first and second light output coupling optical units.

The base of the retrofit lamp according to various embodiments may have a base housing, in which the at least one semiconductor light source is arranged. As a result, the at least one semiconductor light source is protected from contact and damage and, moreover, a direct light emission of the retrofit lamp without detour via the light-guide apparatus and light output coupling optical units is prevented. The base housing shadows light which is emitted by the at least one semiconductor light source and which is not coupled into the light-guide apparatus.

In various embodiments, a light-entrance end of the light-guide apparatus of the retrofit lamp according to various embodiments is arranged in the base housing in order to protect the light-entrance end of the light-guide apparatus, into which the light produced by the at least one semiconductor light source is coupled, from contact and damage.

The at least one semiconductor light source of the retrofit lamp according to various embodiments may be arranged on an assembly circuit board. This facilitates a simple assembly and electrical contacting of the at least one semiconductor light source. In various embodiments, additional electronic components of an operating circuit for the at least one semiconductor light source may be arranged on the assembly circuit board and connected to the at least one semiconductor light source, for example by way of conductor tracks likewise arranged on the assembly circuit board. The assembly circuit board may be arranged in the base housing of the retrofit lamp according to various embodiments.

In various embodiments, the light-guide apparatus of the retrofit lamp according to various embodiments is fixed to the assembly circuit board or to the base by means of a holder. This facilitates fixing the light-guide apparatus and the light output coupling optical units, connected therewith, of the retrofit lamp according to various embodiments to the base or to the assembly circuit board, and adjusting the light output coupling optical units in respect of the reference plane of the base.

The retrofit lamp according to various embodiments advantageously includes a cooling body for the at least one semiconductor light source in order to dissipate heat produced by the at least one semiconductor light source and the operating circuit thereof to the outside. The cooling body is preferably thermally coupled to the assembly circuit board on which the at least one semiconductor light source and the operating circuit thereof are arranged. The cooling body is preferably equipped with cooling ribs, arranged outside of the base housing, in order to ensure ideal cooling.

The retrofit lamp according to various embodiments may include a converging lens apparatus arranged between the at least one semiconductor light source and the at least one light-entrance end of the light-guide apparatus in order to ensure efficient light input coupling of the light emitted by the at least one semiconductor light source into the light-guide apparatus.

The at least one semiconductor light source of the retrofit lamp according to various embodiments may be embodied as a white-light-emitting light-emitting diode. Alternatively, the at least one semiconductor light source may also be embodied as a laser diode which produces and emits blue light during operation, said blue light being converted in portions thereof into light with a different wavelength, e.g. light from the yellow spectral range, by means of a phosphor element, such that a mixture of non-converted laser light and converted light yielding white light is produced at the phosphor element. The phosphor element may be arranged at the light-entrance end or at the light-exit end of the light-guide apparatus or embodied as a coating of the surface of the light output coupling optical units.

In various embodiments, the retrofit lamp includes a plurality of light-emitting diodes arranged in rows and columns, said diodes producing white light during operation, the white light being coupled into the at least one light-entrance end of the light-guide apparatus by means of a converging lens apparatus in order to produce white light with a high brightness and luminance.

The retrofit lamp according to various embodiments may be used in a vehicle headlight, for example for producing a dimmed beam, a high beam or further light functions such as e.g. a fog light and a position light etc.

The retrofit lamp according to various embodiments may be used as a light source in any type of vehicle.

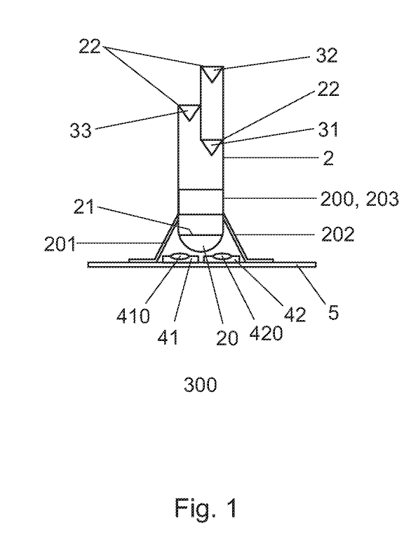

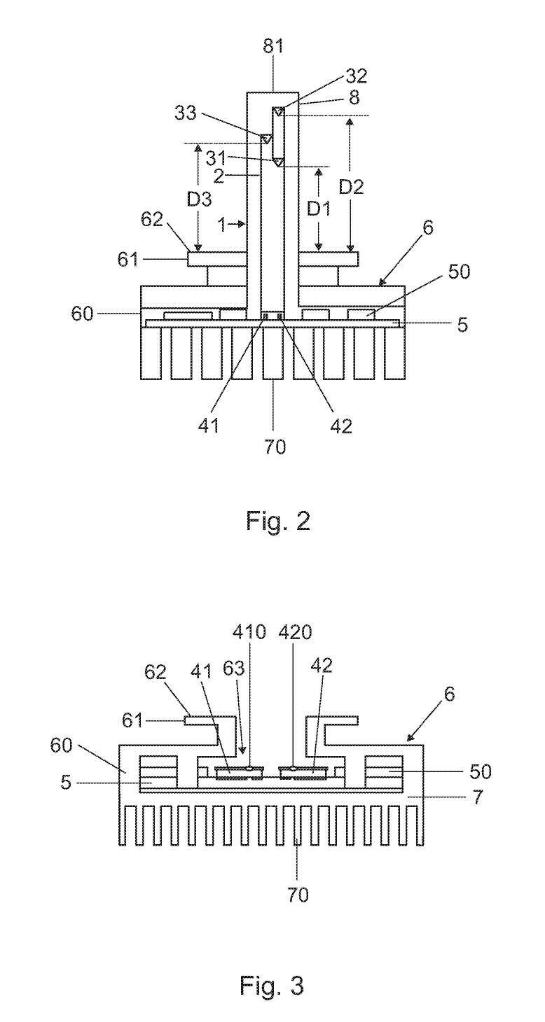

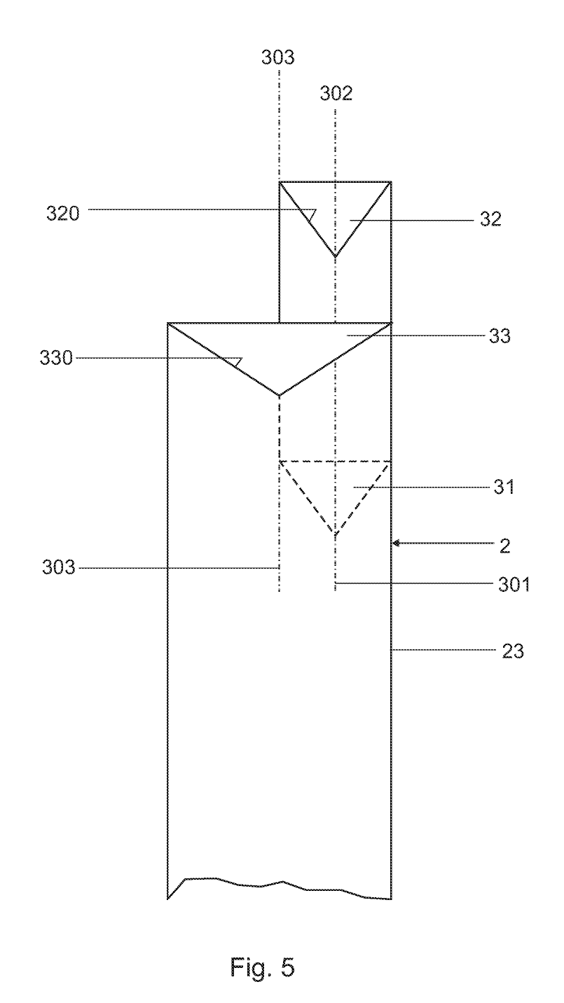

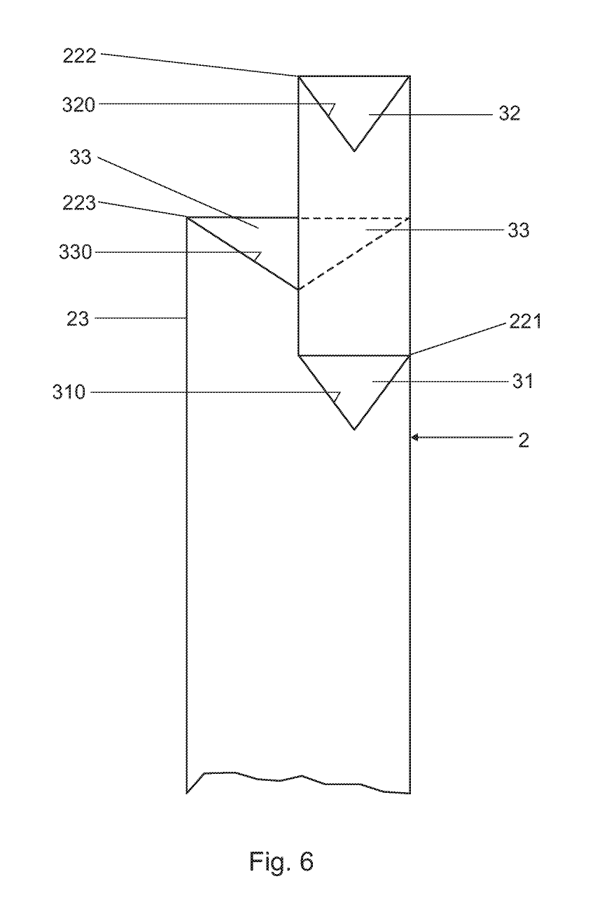

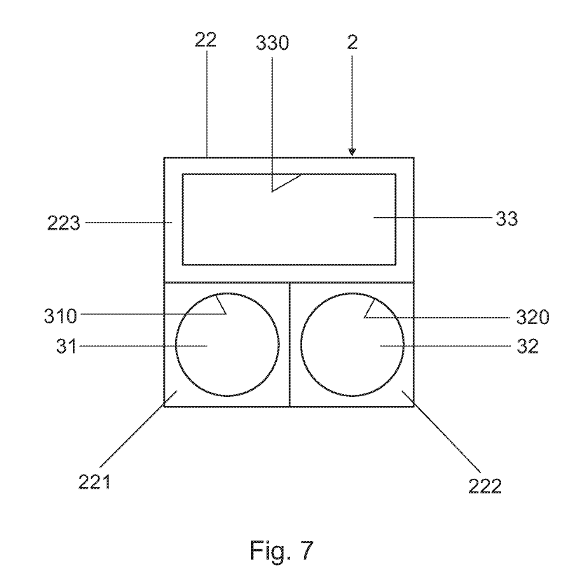

FIG. 1 to FIG. 7 schematically depict details of a retrofit lamp 1 in accordance with various embodiments. The retrofit lamp 1 in accordance with various embodiments serves as a light source in a vehicle headlight and is used, for example, for producing a high beam or a dimmed beam or for both aforementioned light distributions. In various embodiments, the retrofit lamp 1 is compatible with a high-pressure discharge lamp of ECE categories D1s, D2s, D3s and D4s, and may therefore be used as a replacement for such a high-pressure discharge lamp in a vehicle headlight.

The retrofit lamp 1 in accordance with various embodiments includes six semiconductor light sources 410, 420, a converging lens apparatus 20, a light-guide apparatus 2, a holder 200 for the light-guide apparatus, three light output coupling optical units 31, 32, 33, an assembly circuit board 5 for the semiconductor light sources and for components 50 of a circuit arrangement for operating the semiconductor light sources, a base 6, a cooling body 7 and a lamp vessel 8.

The semiconductor light sources of the retrofit lamp 1 in accordance with various embodiments are embodied as two LED chips 41, 42, which each have three light-emitting diodes 410 and 420, respectively, arranged in a row. The two LED chips 41, 42 are affixed next to one another on the assembly circuit board 5 such that the semiconductor light sources 410, 420 of the two LED chips 41, 42 are arranged in two parallel rows and three parallel lines on the surface of the assembly circuit board 5. The total of six semiconductor light sources 410, 420 are each embodied as light-emitting diodes which emit white light during operation. By way of example, the LED chips 41, 42 are embodied in a chip-on-board configuration in order to ensure a compact design. The LED chips 41, 42 may be operated with DC current, e.g. with pulse-width modulated DC current. This allows the light output to be matched to the requirements. In various embodiments, this allows e.g. an increase in the light output in the case of rain. Further, it is possible to dynamically regulate the power of the light-emitting diodes 410, 420 and, for example, operate the light-emitting diodes 410, 420 with an elevated power immediately after switch on, for example in order to imitate the start-up operation of the high-pressure discharge lamp. The light-emitting diodes 410, 420 may be actuated individually or in groups.

The assembly circuit board 5 is embodied as an IMS printed circuit board. The abbreviation IMS denotes an “insulated metal substrate”. Components 50 of a circuit arrangement for operating the LED chips 41, 42 are additionally arranged on the assembly circuit board 5 and electrically contacted by conductor tracks likewise present on the assembly circuit board 5.

The base 6 includes a base housing 60, in the interior of which the assembly circuit board 5 with the LED chips 41, 42 and components 50 of the operating circuit assembled thereon is housed. A bottom of the base housing 60 is embodied as a metallic cooling body 7 which is thermally coupled to the LED chips 41, 42 and the components 50 of the operating circuit. The assembly circuit board 5 is fixed to the bottom of the base housing 60 and hence to the cooling body 7. The cooling body 7 includes cooling ribs 70, which are arranged outside of the interior of the base housing 60 on the bottom of the base housing 60. On a top side lying opposite the bottom, the base housing 60 includes a ring-shaped base flange 61 which serves to assemble the retrofit lamp 1 in the socket of a vehicle headlight. The top side of the base housing 60 has a perforation 63 in the region of the base flange 61. The base 6 includes a reference plane 62 which is defined by a ring-disk-shaped surface of the base flange 61 on the outer side of the base housing 60.

The light-guide apparatus 2 has an embodiment that is analogous to an optical waveguide and consists of a transparent material, for example quartz glass or a transparent plastic. It includes a core and cladding, wherein the core consists of e.g. pure quartz glass and the cladding consists of e.g. doped quartz glass such that the cladding of the light-guide apparatus 2 has a lower optical refractive index than the core thereof. Alternatively, the light-guide apparatus 2 may also consist of transparent silicone. The light-guide apparatus 2 has a rigid and rod-like embodiment and includes a light-entrance end 21, which faces the surface of the assembly circuit board 5 and the LED chips 41, 42, and light-exit end 22, which has a step-like embodiment and which faces away from the LED chips 41, 42 and on which the light output coupling optical units 31, 32, 33 are arranged. The stepped light-exit end 22 of the light-guide apparatus includes a total of three steps 221, 222, 223, the end areas or surfaces of which are arranged at different distances from the reference plane 62 of the base 6. The light-guide apparatus 2 has a square cross section with a side edge length of 3.5 mm. However, alternatively, the light-guide apparatus 2 may also have a rotationally symmetric embodiment with respect to the axis of longitudinal extent thereof and, for example, have an embodiment as a circularly cylindrical rod. However, the dimensions of the light-guide apparatus perpendicular to the axis of longitudinal extent thereof or the diameter thereof may also vary along the axis of longitudinal extent thereof. By way of example, the dimensions of the light-guide apparatus 2 may decrease perpendicular to the axis of longitudinal extent thereof in the direction of the light-exit end. The light-guide apparatus 2 is fastened to the assembly circuit board 5 by means of the holder 200 and aligned approximately perpendicular to the surface of the assembly circuit board 5. The light-guide apparatus 2 protrudes from the base housing 60 through the perforation 63.

A converging lens apparatus 20 which collects light emitted by the light-emitting diodes 410, 420 of the LED chips 41, 42 and focuses said light onto the light-entrance end 21 is arranged in the region between the two LED chips 41, 42 and the light-exit end 22 of the light guide 2. The converging lens apparatus 20 is only depicted schematically in FIG. 1. It may consist of a system of a plurality of optical elements. However, it may be realized by convex arching of the light-entrance end 21 of the light-guide apparatus 2.

The holder 200 of the light guide 2 includes a metallic fastening ring 203 which surrounds the light-guide apparatus 2 with a press fit, and at least two metallic fastening straps 201, 202, which are in each case welded to the fastening ring 203 at one end and fastened to the assembly circuit board 5 with the other end thereof.

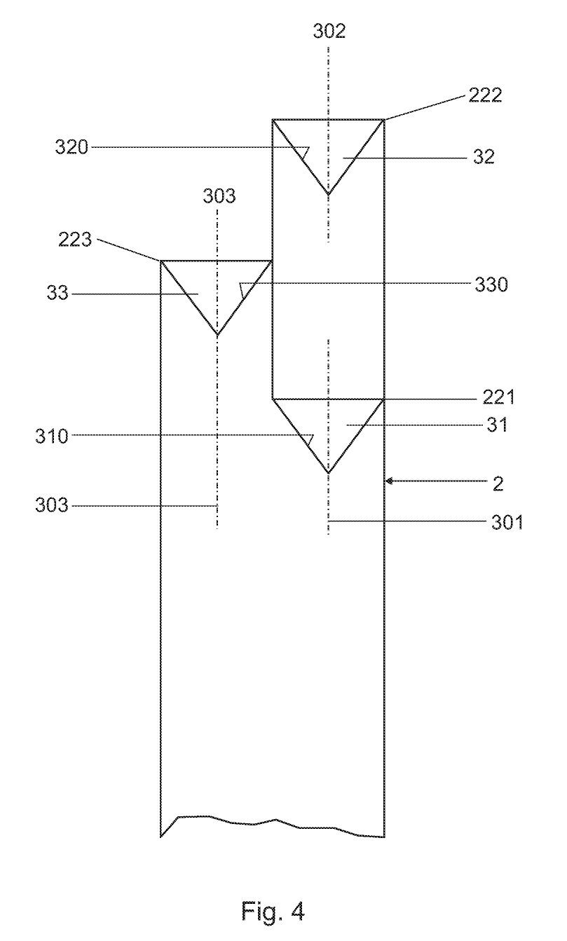

The light output coupling optical units 31, 32, 33 are formed in each case by surfaces 310, 320, 330 with a light-reflecting embodiment, which each delimit a funnel-like cavity arranged within a light-guide apparatus 2, with the cavity in each case extending in the direction of the light-entrance end 21 of the light-guide apparatus 2 proceeding from a step 221, 222 or 223 of the light-exit end 22 of the light-guide apparatus 2. The funnel-like cavities 31, 32, 33 are each delimited by a light-reflecting surface 310, 320 or 330 of the light-guide apparatus 2. The surfaces 310, 320, 330 have a metallic coating in order to ensure a high degree of light reflection. FIG. 4 to FIG. 7 schematically depict different views of the light output coupling optical units 31, 32, 33, with components arranged in the background being depicted using dashed lines in each case.

The first light output coupling optical unit 31 is formed by the light-reflecting surface 310 which delimits a cone-shaped cavity in the first step 221 of the light-exit end 22 of the light-guide apparatus 2, with the cone tip pointing in the direction of the light-entrance end 21 and the opening of the cone-shaped cavity being arranged in the end area or surface of the first step 221 of the light-exit end 22 of the light-guide apparatus 2. The lateral cone area of the cavity or of the first light output coupling optical unit 31 is formed by the light-reflecting, metallized surface 310. The cone axis of the cone-shaped cavity is an axis of rotational symmetry 301 of the first light output coupling optical unit 31.

The second light output coupling optical unit 32 is formed by the light-reflecting surface 320 which delimits a cone-shaped cavity in the second step 222 of the light-exit end 22 of the light-guide apparatus 2, with the cone tip pointing in the direction of the light-entrance end 21 and the opening of the cone-shaped cavity being arranged in the end area or surface of the second step 222 of the light-exit end 22 of the light-guide apparatus 2. The lateral cone area of the cavity or of the second light output coupling optical unit 32 is formed by the light-reflecting, metallized surface 320. The cone axis of the cone-shaped cavity is an axis of rotational symmetry 302 of the second light output coupling optical unit 31.

The retrofit lamp 1 and the reflector 9 of the vehicle headlight are operated with a horizontally extending optical axis 900. Accordingly, the axes of rotational symmetry 301, 302 of the first light output coupling optical unit 31 and the second light output coupling optical unit 32 are arranged in a common horizontal plane.

The third light output coupling optical unit 33 is formed by the light-reflecting surface 330 which delimits a pyramid-shaped cavity in the third step 223 of the light-exit end 22 of the light-guide apparatus 2, with the pyramid tip pointing in the direction of the light-entrance end 21 and the opening of the pyramid-shaped cavity being arranged in the end area or surface of the third step 223 of the light-exit end 22 of the light-guide apparatus 2. The opening of the pyramid-shaped cavity 33 in the surface of the third step 223 is rectangular. The lateral pyramid area of the cavity or of the third light output coupling optical unit 33 is formed by the light-reflecting, metallized surface 330. The pyramid axis 303 of the pyramid-shaped cavity 33, which extends through the pyramid tip and centrally through the rectangular base area of the pyramid form of the cavity 33, is an axis of symmetry 303 of the third light output coupling optical unit 33 with a two-fold rotational symmetry. That is to say, the third light output coupling optical unit 33 is invariant in relation to rotations through an angle of 180° about the pyramid axis 303 thereof, which is therefore also referred to as axis of rotational symmetry 303 of the third light output coupling optical unit below.

The position and orientation of the light output coupling optical units 31, 32, 33 are aligned in respect of the reference plane 62 of the base 6.

The first light output coupling optical unit 31 is arranged at a distance D1 of D1=25.1 mm from the reference plane 62 of the base 6. The second light output coupling optical unit 32 is arranged at a distance D2 of D2=29.1 mm from the reference plane 62 of the base 6. The distance between the cone tips of the first light output coupling optical unit 31 and the second light output coupling optical unit 32 is therefore 4 mm and corresponds to the electrode spacing of the high-pressure discharge lamp which is compatible with the retrofit lamp 1 according to various embodiments. The third light output coupling optical unit 33 is arranged at a distance D3 of D3=E=27.1 mm from the reference plane 62 of the base 6. The pyramid axis or two-fold axis of rotational symmetry 303 of the third light output coupling optical unit 33 is arranged with parallel offset from the axes of rotational symmetry 301, 302 of the first light output coupling optical unit 31 and second light output coupling optical unit 32 and extends above a horizontal plane defined by the axes of rotational symmetry 301, 302 of the first light output coupling optical unit 31 and second light output coupling optical unit 32.

The lamp vessel 8 has a tube-shaped, in particular hollow cylindrical embodiment, consists of glass or a transparent plastic and is arranged coaxially in relation to the light-guide apparatus 2. The lamp vessel 8 is fastened with a press fit to the edge of the perforation 63 on the base housing and surrounds the portion of the light-guide apparatus 2 projecting from the base housing 60. The lamp vessel 8 serves to protect the light-guide apparatus 2 and the light output coupling optical units 31, 32, 33 from contact and damage. The end 81 of the lamp vessel 8 which protrudes out of the perforation 63 of the base housing 60 and projects beyond the light output coupling optical unit 3 is sealed in order to prevent the ingress of dirt into the lamp vessel 8. By way of example, the interior of the lamp vessel 8 is evacuated or filled with gas or a gas mixture. By way of example, the filling gas or filling gas mixture contains air or an inert gas or a mixture of air and an inert gas, wherein nitrogen, SF6 and noble gases and mixtures thereof may be provided as an inert gas.

White light which is coupled into the light-entrance end 21 of the light-guide apparatus 2 by means of the converging lens apparatus 20 is produced by the light-emitting diodes 410, 420 during the operation of the retrofit lamp 1. In the interior of the light-guide apparatus 2, the coupled-in light is guided to the stepped light-exit end 22 of the light-guide apparatus 2 by total internal reflection at the cladding thereof. In the region of the light output coupling optical units 31, 32, 33, the light guided in the interior of the light-guide apparatus 2 is reflected back into the light guide 2 when it is incident on the metallized surface 310, 320, 330 of the light output coupling optical units 31, 32, 33, and so some of this light is incident on the lateral area 23 of the light-guide apparatus 2 at an angle which is smaller than the angle of total-internal reflection, and hence it leaves the light-guide apparatus 2 via the lateral area 23 thereof. The light which is produced by the light-emitting diodes 410, 420 and coupled into the light guide 2 is substantially emitted level with the light output coupling optical units 31, 32, 33 by way of the lateral area 23 of the light-guide apparatus 2. The first light coupling optical unit 31 and the second light coupling optical unit 32 emit light during the lamp operation, which light in each case imitates an electric arc attachment at an electrode of a high-pressure discharge lamp. During the lamp operation, the third light output coupling optical unit 33 emits light which imitates a convection-caused upwardly curved electric arc center.

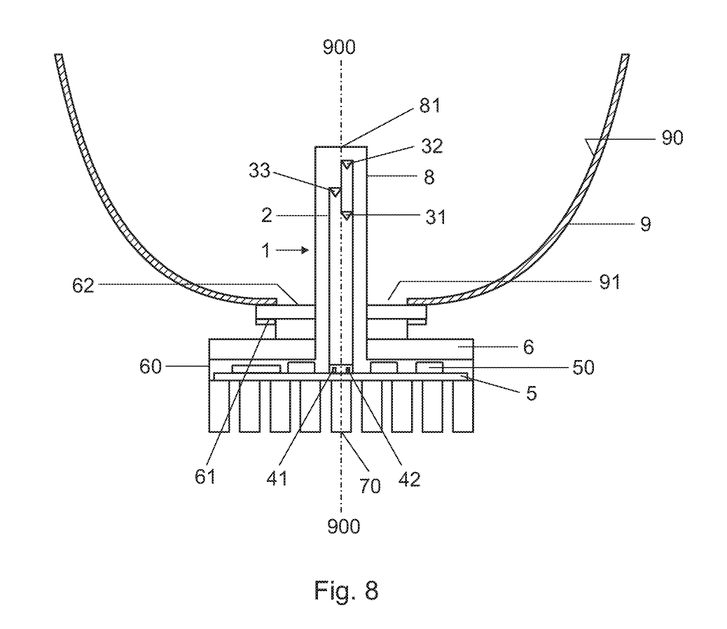

FIG. 8 depicts, schematically and partly cut, a vehicle headlight including a retrofit lamp 1 in accordance with various embodiments. The vehicle headlight includes a reflector 9 with a light-reflecting reflection area 90 and optical axis 900. By way of example, the reflection area 90 is embodied as a parabola or with an ellipsoid shape or as a free-form surface. The retrofit lamp 1 is fastened by means of the base flange 61 thereof in an assembly opening 91 of the reflector 9. The base 6 or the base flange 61 of the retrofit lamp 1 and the assembly opening 91 of the reflector 9 or of the vehicle headlight have fastening means (not depicted here) which are matched to one another and which ensure that the retrofit lamp 1 is fixed in the reflector 9. The reference plane 62 adjoins on the outer side of the reflector 9. The axes of rotational symmetry 301, 302, 303 of the light output coupling optical units 31, 32, 33 are arranged with parallel offset to the optical axis 900 of the reflector 9. The reflector 9 and the retrofit lamp 1 are operated with a horizontally extending optical axis 900. The axis of symmetry 303 of the third light output coupling optical unit 33 may be arranged above the axes of rotational symmetry 301, 302 of the first light output coupling optical unit 31 and second light output coupling optical unit 32 in order thereby to imitate a convection-caused upwardly curved discharge arc. The two axes of rotational symmetry 301, 302 of the first light output coupling optical unit 31 and second light output coupling optical unit 32 may be arranged at a distance of approximately 1.8 mm from one another in a common horizontal plane.

The embodiments are not restricted to the embodiments explained in more detail above.

By way of example, differently formed light output coupling optical units, which e.g. each have a frustum-like portion adjoining the cone-like portion, could be used instead of the above-described light output coupling optical units.

Further, the light-guide apparatus of the retrofit lamp according to various embodiments may have a tapering embodiment in the direction of the stepped light-exit end thereof in order e.g. to ensure higher stability and resistance in relation to tremors. In various embodiments, the light-guide apparatus may have a larger diameter in the region of the light-entrance end thereof than in the region of the light-exit end thereof.

Moreover, the number and type of the semiconductor light sources of the retrofit lamp according to various embodiments may be modified. By way of example, one or more laser diodes may be used in place of the LED chips in the retrofit lamp according to various embodiments. In various embodiments, the light of one or more laser diodes may be coupled into the light-guide apparatus by means of a converging lens apparatus and may be emitted by way of the light output coupling optical units, wherein the laser light, e.g. blue laser light, is converted in part into light with a different wavelength by means of a phosphor element in order to produce white light as a mixture of converted light and non-converted laser light. By way of example, the phosphor element is a light-transmissive ceramic disk made of cerium-doped yttrium aluminum garnet (YAG:Ce), which is arranged on the light-entrance end 21 of the light-guide apparatus 2. Alternatively, the phosphor element may also be formed as a coating of the surface of the light-guide apparatus in the region of the light output coupling optical units.

Moreover, the retrofit lamp according to various embodiments may also be equipped with semiconductor light sources which emit single-colored or multi-colored light in order, for example, to implement a signal-light function such as e.g. braking light or a turn indicator.

Furthermore, the assembly circuit board 5 may contain further functional elements, such as e.g. optical sensors, Peltier cooling elements and heating elements which, for example, serve to preheat the LED chips at low temperatures, in particular temperatures below 0° C.

Further, the lamp vessel 8 of the retrofit lamp according to various embodiments may have a light-opaque coating embodied as an optical stop in order to modify the light distribution of the retrofit lamp. By way of example, the light-opaque coating embodied as an optical stop may be embodied on the lamp vessel in such a way that a light-transmissive window is defined on the surface of the lamp vessel in order to produce a dimmed light distribution. In various embodiments, the form of the light-opaque coating on the lamp vessel 8 embodied as an optical stop may correspond to the form of such a coating on the outer bulb of a high-pressure discharge lamp of ECE category D1R, D2R, D3R, D4R, or D8R such that the retrofit lamp according to various embodiments is usable as a replacement for such a high-pressure discharge lamp in the vehicle headlight.

### LIST OF REFERENCE SIGNS

1 Retrofit lamp

2 light-guide apparatus

21 Light-entrance end of the light-guide apparatus

22 Light-exit end of the light-guide apparatus

23 Lateral area of the light-guide apparatus

20 Converging lens apparatus

200 Holder of the light-guide apparatus

201, 202 Fastening straps

203 Fastening ring

221, 22, 223 Steps at the light-exit end

31, 32, 33 Light output coupling optical units

301, 302, 303 Axes of rotational symmetry of the light output coupling optical units

310, 320, 330 Lateral areas of the light output coupling optical units

41 LED chip

42 LED chip

410 Light-emitting diode

420 Light-emitting diode

5 Assembly circuit board

50 Components of the operating circuit

6 Base

60 Base housing

61 Base flange

62 Reference plane of the base

63 Perforation in the base housing

7 Cooling body

70 Cooling ribs

8 Lamp vessel

81 End of the lamp vessel

9 Reflector

90 Reflection area

91 Assembly opening of the reflector

900 Optical axis

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A retrofit lamp for vehicle headlight, the retrofit lamp comprising:
at least one semiconductor light source;
a plurality of light output coupling optical units; and
a light-guide apparatus which is embodied to guide light from the at least one semiconductor light source to the light output coupling optical units;
wherein the light-guide apparatus comprises at least one light-exit end, at which the light output coupling optical units are arranged spaced apart from one another.

2. The retrofit lamp of claim 1,
wherein the light-guide apparatus has a step-like embodiment at the at least one light-exit end and the light output coupling optical units are each arranged on one step of the light-exit end of the light-guide apparatus.

3. The retrofit lamp of claim 1,
wherein the light output coupling optical units each have a rotationally symmetric embodiment in respect of an axis of rotational symmetry.

4. The retrofit lamp of claim 1,
wherein the light output coupling optical units comprise at least one portion with a cone-like or frustum-like or pyramid-shaped embodiment and with a light-reflecting surface.

5. The retrofit lamp of claim 1,
wherein one or more of the light output coupling optical units are formed by surfaces with a light-reflecting embodiment, which are arranged within the light-guide apparatus.

6. The retrofit lamp of claim 1,
wherein one or more of the light output coupling optical units are formed by surfaces with a light-reflecting embodiment, which each delimit a cavity arranged within the light-guide apparatus.

7. The retrofit lamp of claim 1,
wherein the retrofit lamp comprises a base which defines a reference plane for aligning the light output coupling optical units.

8. The retrofit lamp of claim 2,
wherein the axes of rotational symmetry of the light output coupling optical units are aligned perpendicular to the reference plane in each case.

9. The retrofit lamp of claim 7,
wherein at least two light output coupling optical units are present and the distance between a first light output coupling optical unit and the reference plane is less than a value E and the distance between a second light output coupling optical unit and the reference plane is greater than the value E, and wherein the value E is either 27.1 mm or 18.0 mm.

10. The retrofit lamp of claim 9,
wherein a third light output coupling optical unit is additionally present and the distance between the third light output coupling optical unit and the reference plane is greater than the distance between the first light output coupling optical unit and the reference plane and less than the distance between the second light output coupling optical unit and the reference plane.

11. The retrofit lamp of claim 7,
wherein the base comprises a base housing, in which the at least one semiconductor light source is arranged.

12. The retrofit lamp of claim 11,
wherein a light-entrance end of the light-guide apparatus is arranged in the base housing.

13. A vehicle headlight, comprising:
at least one retrofit lamp, comprising:
at least one semiconductor light source;
a plurality of light output coupling optical units; and
a light-guide apparatus which is embodied to guide light from the at least one semiconductor light source to the light output coupling optical units;
wherein the light-guide apparatus comprises at least one light-exit end, at which the light output coupling optical units are arranged spaced apart from one another;

14. The vehicle headlight of claim 13,
wherein the vehicle headlight comprises a reflector with an optical axis and the at least one retrofit lamp is arranged in the vehicle headlight in such a way that the optical axis of the reflector is arranged perpendicular to the reference plane of the base of the retrofit lamp.
